(19) United States
(12) Patent Application Publication
(10) Pub. No.: US 2016/0345544 A1
(43) Pub. Date: Dec. 1, 2016

(54) BROILER CHICKEN CONTAINER AND UNIT COMPRISING AT LEAST TWO BROILER CHICKEN CONTAINERS, SAID CONTAINER BEING DESIGNED AND EQUIPPED TO RECEIVE AND HOLD BROILER CHICKENS

(71) Applicant: LINCO FOOD SYSTEMS A/S, Trige (DK)

(72) Inventor: Uffe Thrane, Hammel (DK)

(21) Appl. No.: 15/116,811

(22) PCT Filed: Feb. 5, 2015
(86) PCT No.: PCT/EP2015/052390

§ 371 Date: Aug. 4, 2016

(30) Foreign Application Priority Data
Feb. 5, 2014 (DK) PA 2014 70064

(51) Int. Cl. A01K 31/00; A01K 45/00; A01K 31/07; B65D 21/02

(52) U.S. Cl. CPC A01K 31/002; B65D 21/0212; A01K 45/005; A01K 31/07

(57) ABSTRACT

The invention relates to a broiler container, designed and adapted for accommodating and holding broilers, having a floor and side walls defining an inner volume, the broiler container designed and adapted to be stackable with broiler containers of the same design, characterized in that at least one support column extends from the floor up through the inner volume, that the support column is distanced from all the side walls providing space for at least one broiler in between the support column and any of the side walls, and that the support column (14, 114, 214, 314, 414) has a height to support the floor of a further broiler container (1, 101, 201, 301, 401) stacked on top of the broiler container. The invention further relates to a unit having at least two of the afore-mentioned broiler containers.

### CROSS REFERENCE TO RELATED APPLICATION

This application is a National Stage of International Patent Application No. PCT/EP2015/052390 filed on Feb. 5, 2015, which claims the benefit of Danish Patent Application No. PA 2014 70064 filed on Feb. 5, 2014, the disclosures of which are hereby incorporated entirely herein by reference.

### BACKGROUND

Technical Field

The invention relates to a broiler container, designed and adapted for receiving and holding broilers, having a floor and side walls defining an inner volume, the broiler container being designed and adapted to be stackable with broiler containers of the same design.

The invention further relates to a unit, designed and adapted for receiving and holding live broilers during rearing and/or during transport of the broilers to a slaughterhouse and/or during lairage of the broilers before being processed in the region of the slaughterhouse, comprising at least two broiler containers.

State of the Art

Broiler containers (also called containers and broiler transport containers in the following) of this type are known for example from GB 2 129 672 A and EP 0 867 113 A2 and have found very wide use particularly in the transportation of poultry from farms to slaughterhouses. Common to the containers known from these documents, and many others used today, is a structure with a plurality of ventilation openings in the sides and bottom and a reinforcing rib structure, which allows a container of limited weight to be filled to its maximum with slaughter-ready broilers.

Broilers are slaughter-ready chickens or hens or turkeys grown to be ready for being slaughtered for providing meat to consumers, and they have a fully developed feathering and a considerable weight of at least 1.6 kg per broiler.

### SUMMARY

An overview of current practices is given by the European Food Safety Authority in the scientific report “Overview on current practices of poultry slaughtering and poultry meat inspection”, by Dr Ulrich Lohren, Supporting Publications 2012: EN-298. In the report the broiler containers are called crates, and they are to be distinguished from liners, which are cages fixed on the truck, and container systems, which are transport units having several floors in a fixed frame, as described in for example EP 0 384 530 A1. According to the report 30% of current (year 2012) broiler transport takes place in the broiler transport containers relevant to the present invention, and 70% of the transport takes place in container systems.

Both the broiler transport containers and also the container systems are excellent when considering only the transport from the farm to the slaughterhouse, but experience has shown that they are relatively difficult to clean, leading to a risk of cross-infection between farms, when broiler containers or container systems are returned for use in another transportation cycle. To counteract this potential bio-security problem most slaughterhouses have been equipped with advanced cleaning systems, including highly specialized container washers and often also soaking tanks.

The broiler transport containers rely on being placed in and held during transport in frame systems as described for example in EP 1 330 952 B1. These frames also need cleaning, and require rather large washing machines due to their size.

Both the frames as such, and in particular the broiler transport containers can pose a particular cross-infection problem, involving collection of dirt in the bottom structure, since they are usually set down directly onto the floor of the stable, which is by nature contaminated with bird droppings. The reinforcement ribs at the bottom of the broiler transport containers typically extend in crossing patterns resulting in a bottom having many rows of cubic voids in which dirt can collect and adhere to the sides of the ribs. The frames have recesses for fork lift blades. During driving with the frame in the stable just prior to the loading onto the transport trailer it happens that dirt from the floor is scraped into the recesses and transferred to the trailer together with the frame with broiler transport containers carrying the live broilers. Such dirt collection can result in a large mass of dirt loaded onto the trailer.

The weight loading capacity of a transport trailer is limited, typically to about 24 t for a standard trailer, and the height loading capacity is typically limited to 2.7 m for a standard trailer. Other limits may apply to special trailer sizes, such as trailers with twin axle bogies or trailers with additional bogies, XL large lorries etc. The problem with current broiler transport containers and broiler transport container systems, however, is independent from the type of trailer, namely that they collect dirt, and collected dirt in the bottom areas is carried onto the trailer.

It is therefore an object of the invention to provide a broiler container improved with respect to hygiene and stability which ensures the animal welfare of the broilers.

This object is solved by a broiler container of the above-mentioned kind in that at least one support column extends from the floor up through the inner volume, that the support column is distanced from all the side walls providing space for at least one broiler in between the support column and any of the side walls, and that the support column has a height to support the floor of a further broiler container stacked on top of the broiler container.

Particularly preferably, the broiler container is sized as well as designed and adapted for transport of at least five live broilers.

As the support column extends from the floor, the feet of the broilers cannot get caught at the column as there is no void between floor and the column, and the spacing of the column from all side walls also prevents a broiler from getting squeezed in and hurt between the column and a side wall.

The additional support at a distance from the sides of the container provided by the at least one column also allows in particular the floor of the broiler transport container to be of a design with less or no reinforcing rib structure in the bottom area, thus minimizing collection of dirt and making cleaning easier. Even though the at least one column takes up some floor area, which would otherwise be available for the broilers, the weight of the broiler transport container per kilo broiler loaded into the broiler transport container is comparable with or lower than in the current broiler transport systems.

The provision of the at least one support column provides support for containers being positioned on top of another in a stack, thereby reducing the need for reinforcement ribs and allowing the containers to be made with smoother outer surfaces that are easier to clean. The broiler transport containers may be inserted in frames as in the prior art systems, but they are particularly suited for being arranged on top of each other in a stack without the use of a frame so as to form a frameless transport unit. The disposal of the separate frame makes it possible to simplify the washing installations at the slaughterhouse, and cross-infection via the frame is completely avoided. When use of the frame can be avoided, the handling is more efficient, and a considerable reduction of the total weight of the transport system itself is obtained, thus allowing the weight of the broilers loaded, i.e. the net weight, to be higher.

Although the floor of the broiler transport container can be made with holes in the floor area, it is preferred in an embodiment of the broiler transport container that the floor has an outer surface, which outer surface is plate shaped and without openings in the areas between the at least one support column and the side walls. This provides for easier cleaning and less risk of contamination because dirt cannot easily affix to a plane surface without openings.

In a further embodiment the floor has an inner surface, which inner surface is plate shaped and without openings in the areas between the at least one support column and the side walls. This is an advantage to broiler welfare as the toes of the broilers cannot get caught in holes in the floor. When the broiler transport container is emptied for broilers at the slaughterhouse, the broilers are quickly removed, and if a foot or a toe is caught in a hole in the bottom the foot or toe may be torn off. This problem is avoided by using a plate shaped floor of closed construction.

The floor as such need not be in one plane, but may include a plurality of planar, plate shaped sections, one example being that the floor is made as a trapezoidol sheet. In other embodiments, the floor may be made with variations in the material thickness in the areas between the at least one support column and the side walls, the thicker areas preferably extending between opposite side walls. In case the container is not having a square base, the thicker areas preferably extend between the opposing side walls that are furthest from each other.

The overall shape of the broiler transport container and the number and position of support columns in relation to the side walls depend amongst others on the size of the container and on the weight of the broilers to be transported. Presently, it preferred that the broiler transport container has four side walls forming two pairs of opposed side walls, that the at least one support column is positioned on the floor at approximately midway between one pair of opposed side walls, and distributed between the other pair of opposed side walls with a spacing of approximately D/(N+1), where D is the distance between the other pair of opposed side walls, and N is the number of support columns in the broiler transport container. This embodiment is in particular advantageous with regards to symmetry, because the broiler transport container can be stacked with the one end or the other end facing the operator, and yet the at least one support column will fit with a corresponding support column in the lower broiler transport container. The filling may take place quickly, such as at a speed of 50 to over 200 broilers per minute, and it is a help to the operator that a broiler transport container cannot be oriented wrongly during the stacking, in particular because the final placement of an empty container may occur at the same time as a broiler delivery opening in a broiler loading apparatus shifts position to deliver broilers to the empty container.

The broiler transport container can also have a triangular footprint and three side walls, or polygonal footprint and five or more side walls.

The shape and size of the at least one support column should be chosen with due regard to maintaining a relatively large inner floor surface area available for the broilers. In an embodiment the at least one support column has annular cross-section with a hollow centre extending along the height of the column. Such a design provides regular surfaces, preferably without corners in the column, which are easy to clean after each transport of broilers.

It is an advantage if the at least one column is shaped in a manner suitability for contact with the broilers, since the risk of injuries, such as bruises and broken wings caused from bumping into a column during filling of the container, should preferably be minimized. If the support column has an outer diameter in the range from 7 cm to 30 cm, particularly in the range from 10 cm to 24 cm, preferably in the range from 12 cm to 21 cm, the risk of the broilers being hurt will be low. If the diameter is well below 7 cm a wing may be subjected to too high a local load when the broiler arrives in the container with high speed. If the diameter is well above 30 cm too much floor area is consumed by each column. It is presently considered particularly advantageous that the column is both rounded, possibly even having a circular crosssection, and has a diameter within the intervals given above.

In order to fixate the broiler transport containers in relation to each other when arranged in a stack to form a frameless transport unit, each broiler transport container may have upper corresponding areas and lower corresponding areas, which upper corresponding areas fit with the lower corresponding areas of a further broiler transport container stacked on top of the broiler transport container. The broiler containers stacked on pallet support as a transport unit are then self-supporting via said upper corresponding areas and lower corresponding areas. Pallets used to form the base of transport units and support the broiler transport units may also be provided with upper corresponding areas adapted to engage the lower corresponding areas on the lowermost broiler transport container of a stack. These upper and lower corresponding areas may be dispensed with when a frame is used to control the mutual positioning of the containers.

In an embodiment, the corresponding areas may be provided in that the at least one support column may have an upper end and a lower end and be provided with an upper corresponding area in its upper end and a lower corresponding area in its lower end. This may for example simply be achieved by making the columns with conical or frustoconical end areas so that the upper end of at least one column on one container fits into a hollow centre in the lower end of a corresponding column on another container.

In order to supplement the engagement between the upper corresponding areas and the lower corresponding areas of the columns, or to serve as an alternative to these, the side walls may have an upper end and a lower end and be provided with upper corresponding areas in the upper end and lower corresponding areas in the lower end. One example of such corresponding areas is that the broiler transport container is provided with a recess at the bottom of each side wall so that the bottom of the container fits into the opening at the top of another container, the recess serving as lower corresponding area and the upper edges of the side walls serving as upper corresponding areas. Alternatively, the upper edges of at least two opposite side walls may be provided with L-shaped flanges projecting outwards and upwards so that they may embrace the lower outer corners at the lower ends of the side walls of another container. In still another embodiment, the side walls and/or the outer surface of the floor are provide with matching openings and projections, such as holes and pins or feathers and grooves, but as such corresponding areas are more difficult to clean, they are presently not preferred.

The corresponding areas need not extend over the entire length of the side walls. Instead, the upper corresponding areas on the side walls may protrude upwards at intermediate portions of the side walls, leaving openings in between upper ends of the intermediate portions and a further broiler transport container stacked on top of the broiler transport container. As an example, the upper corresponding areas may be present only at corners of the container where side walls meet, so that openings extend substantially from one corner to the other over the intermediate portions. If the container is longer and/or wider, it may also be expedient to provide upwards protruding upper corresponding areas for example at the middle of a side wall, so that openings extend substantially from the corners to the middle of the container, or even further such upper corresponding areas may be provided if necessary. When the broiler transport container has four side walls forming two pairs of opposed side walls, upper corresponding areas of this type may be distributed between one or both pair of opposed side walls with a spacing of approximately D/(N+1) as described in the above for the columns, and in some embodiments these upper corresponding areas and the columns may be spaced in the same manner.

With respect to size and dimensions of the broiler transport container it may be expedient for reasons of efficient handling that the containers are as large as possible in order to reduce the work associated with the handling of containers during filling on the farm and emptying at the slaughterhouse. Working environment legislations concerning the maximum weight allowed to be handled by the farm personnel and the possibility for practically handling the containers, however, set upper limits on the size of prior art containers. With the broiler transport containers according to the present invention, it is presently preferred that the length of the broiler transport container is in the range of 2.10 m to 2.80 m, preferably about 2.4 m, and that the width of the broiler transport container is in the range of 0.70 m to 2.6 m, preferably in the range of 0.70 to 0.90 m, and particularly preferably about 0.80 m. A width of 2.4 m corresponds to the width of the platform found on the trucks typically used for the transportation of broilers today and with such broiler transport containers it will thus not be necessary to load two or more transport units next to each other, but instead the platform of the trailer can be filled with a single row of broiler transport container stacks. Transportation using other means may call for other sizes, an example being transportation by rail where wagons may have an available platform width of up to 2.8 m.

As explained in the above with reference to the floor of the container, planar surfaces are easy to clean and it is therefore also preferred that the side walls are substantially planar, and preferably plate shaped without openings other than possible ventilation openings. The design of at least one of the side walls may, however, be such as to enable ventilation, either by allowing an opening between the respective side walls of broiler transport containers arranged on top of each other, or by having ventilation openings through the side wall.

Broiler transport containers according to the invention may be made from any material, which is sufficiently strong and stable to allow the container to be filled with broilers and which is able to withstand thorough cleaning. It is presently preferred that the broiler transport container is made of plastic material, and preferably made by injection moulding. Suitable plastic materials include high density polyethylene (HDPE) and polypropylene, but it is also possible to make the containers from steel, stainless steel, aluminium, metals or composites, such as carbon fibre composites, and/or to provide them with reinforcing inlays of a different material than the rest of the container.

This object is also solved by a unit of the above-mentioned kind in that the broiler containers are designed according to any one of claims 1 to 13.

The broiler transport containers according to the invention can preferably be arranged in stacked configuration with from 3 to 14 broiler transport containers in a single stack, or in a stack of from 6 to 12 broiler transport containers, or in a stack from 3 to 5 broiler transport containers, without the use of a separate frame to hold the individual container. The latter corresponds in numbers to current crate systems with a frame holding from three to five crates. The stack of broiler transport containers can be arranged on a support or on pallet support and constitutes a unit (also called a transport unit in the following) having a basic weight and a total floor area, which total floor area is the sum of the floor areas of the broiler transport containers in the transport unit. In an embodiment, the unit basic weight (in kg) divided by the total floor area (in m²) is at the most 24.0 (kg/m²), and preferably the unit basic weight (in kg) divided by the total floor area (in m²) is in the range from 5 to 24 kg/m², particularly preferably in the range from 10 to 20 kg/m². In comparison, the unit basic weight divided by the total floor area of the prior art employing separate broiler transport containers and a frame is typically approximately 60-100 kg/m². The unit basic weight is to be understood as including all elements of a transport unit, i.e. not only the broiler transport containers but also any supports, pallets, lid, or covers used together with the broiler transport containers when they are moved as a stacked unit or stacked units at the loading onto a trailer, however the weight of broilers is not included in the unit basic weight. The broiler transport containers are preferably stacked on a pallet support in order to facilitate handling of the transport unit, but it is not excluded to use alternatives, such as simply arranging the lowermost broiler transport container of a stack on simple spacers detached from the transport unit to keep it elevated over the supporting surface and allow space for the forks of a forklift. The pallet support may also be in the form of a special type of container being used as the lowermost layer in a stack, in which lowermost container the support is integrated with the container bottom. The design of the pallet and/or lowermost broiler transport container should be such that the risk of it catching dirt and birds droppings when handled on the farm is low, in order both to improve hygiene and to avoid transporting unnecessary dead load.

Although the unit basic weight (in kg) divided by the total floor area (in m²) is preferably at the most 24.0 (kg/m²), it is in certain cases desirable that unit basic weight is higher, such as when the broiler transport container has to withstand the loading of a very high stack, such as 15 broiler transport containers loaded with broilers.

A particularly low weight of the broiler transport container is obtainable when the stack is filled with broilers only in the situation where the bottom of the individual container is supported from below, either by support from a pallet or other support (relevant to the lowermost container in a stack) or by support from the at least one column in the broiler transport container located below the container (relevant to containers stacked above the lowermost container). It is advantageous to fill the broilers firstly into the lowermost container, then place the next container on top of the lowermost and continue to fill broilers into the next container, and so forth as the transport unit is built, and proceed with the emptying of containers from the top container and downwards. The individual broiler transport container thus never has to be lifted at the ends as a separate container, when filled with broilers, and this allows the bottom to be of a low-weight construction.

The broiler containers of the unit preferably have upper corresponding areas and lower corresponding areas, which upper corresponding areas fit with the lower corresponding areas on a further broiler transport container stacked on top of the broiler transport container, and broiler containers stacked on a pallet support as a unit are self-supporting via said upper corresponding areas and lower corresponding areas. The upper corresponding areas on the side walls preferably protrude upwards at intermediate portions of the side walls and leave openings in between upper ends of the intermediate portions and a further broiler container stacked on top of the broiler container. This provides for a particularly stabile unit that is gentle on the broilers.

Further advantages resulting from the unit of the invention have already been described in connection with the broiler container, which is why the relevant passages are referred to in order to avoid repetition.

### BRIEF DESCRIPTION OF THE DRAWINGS

In the following examples of embodiments of the invention will described in further detail with reference to the schematic drawings, in which

FIG. 1 illustrates an embodiment of a broiler transport container in a perspective view seen from above,

FIG. 2 illustrates the broiler transport container in FIG. 1 seen a perspective view seen from below,

FIG. 3 shows a view corresponding to FIG. 2 but seen from a slightly different angle,

FIG. 4 illustrates five crates of the type shown in FIGS. 1 and 2 arranged in a stack on a pallet,

FIG. 5 is a cross-section along the line V-V in FIG. 4,

FIG. 6A is a cross-section along the line VI-VI in FIG. 4,

FIG. 6B shows the detail marked VIB seen from the side indicated by the arrow in FIG. 6A,

FIG. 7 shows the pallet in FIG. 4 in a perspective view from above,

FIG. 8 illustrates another embodiment of a broiler transport container in a perspective view seen from above,

FIG. 9 illustrates the broiler transport container in FIG. 8 in a perspective view seen from below,

FIG. 10 illustrates still another embodiment of a broiler transport container in a perspective view seen from above,

FIG. 11 illustrates the broiler transport container in FIG. 10 in a perspective view seen from below,

FIG. 12 illustrates yet another embodiment of a broiler transport container in a perspective, partially cut-away view seen from above and arranged closely against another broiler transport container of the same type in a pairwise configuration,

FIG. 13 shows a perspective view of a support column as in FIG. 12,

FIG. 14 illustrates yet another embodiment of a broiler transport containers in a perspective, partially cut-away view seen from above, where three such broiler transport container are arranged on top of each other, where the stack is arranged on top of two pallets arranged closely against each other, and where a cover is arranged on top of the uppermost broiler transport container to form a transport unit,

FIG. 15 shows a perspective view of the detail marked XV in FIG. 14,

FIG. 16 illustrates transport units build from broiler transport containers as illustrated in FIGS. 8 and 9 arranged on a truck trailer,

FIG. 17 illustrates yet another embodiment of a broiler transport container having side doors,

FIG. 18 illustrates a still further embodiment of a broiler transport container in a perspective view seen from above,

FIG. 19 is a cross-sectional view of a stack of broiler transport containers as in FIG. 18 along the line XX-XX in FIG. 18, and

FIG. 20 illustrates three different cross-sectional shapes of a floor of broiler transport containers.

### DETAILED DESCRIPTION OF EMBODIMENTS

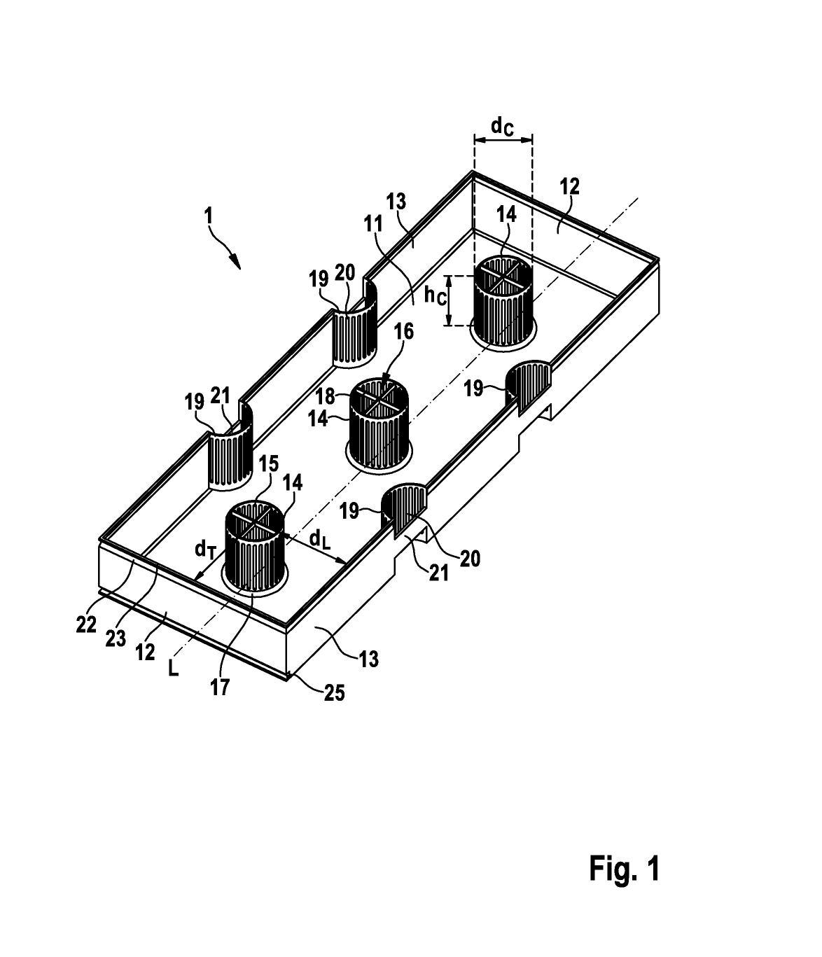

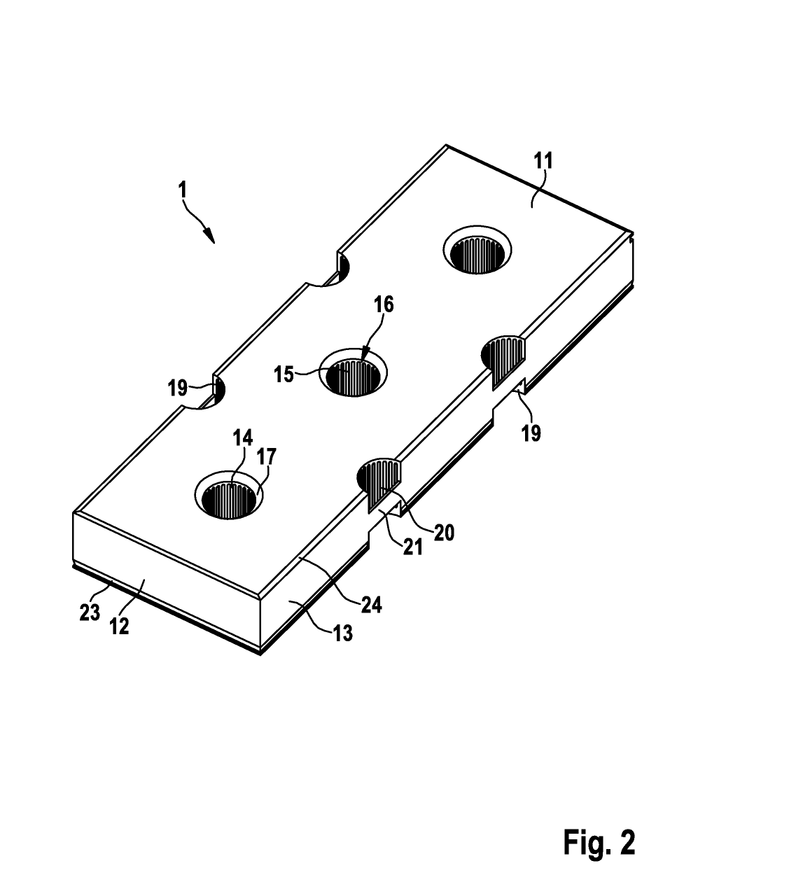

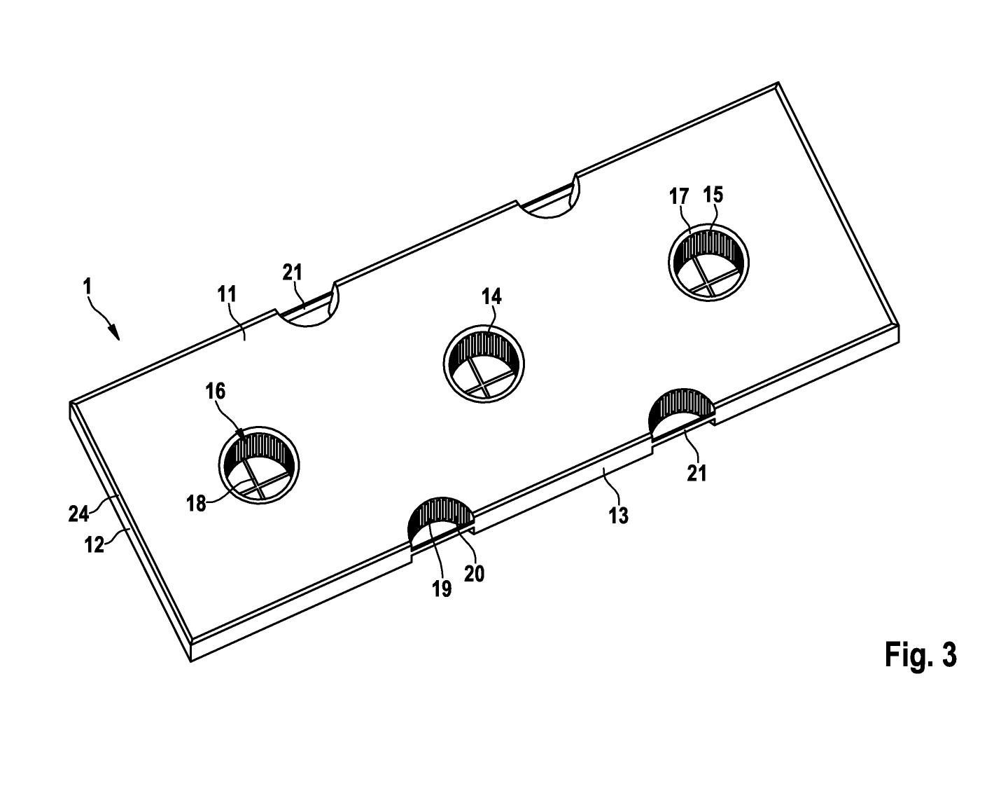

An embodiment of a broiler container 1 according to the invention, particularly for transport of the broilers, is shown in FIGS. 1-3. The broiler containers 1 (also called broiler transport container or container in the following) may also be used stationary, e.g. for rearing of broilers on a farm. The broiler container 1 comprises a rectangular plate shaped floor 11 without openings, two transverse side walls 12 and two longitudinal side walls 13, which together delimit an inner volume sized to accommodate at least five live broilers (not shown). Three columns 14 extend from the floor 11 up through the inner volume at a distance dT from the transverse side walls 12 and a distance dL from the longitudinal side walls 13. These distances dT, dL are adapted for providing space for at least one broiler in between each of the columns 14 and the respective side walls 12,13. The columns 14 are arranged in a row along the centre length axis L of the broiler container 1 and evenly spaced.

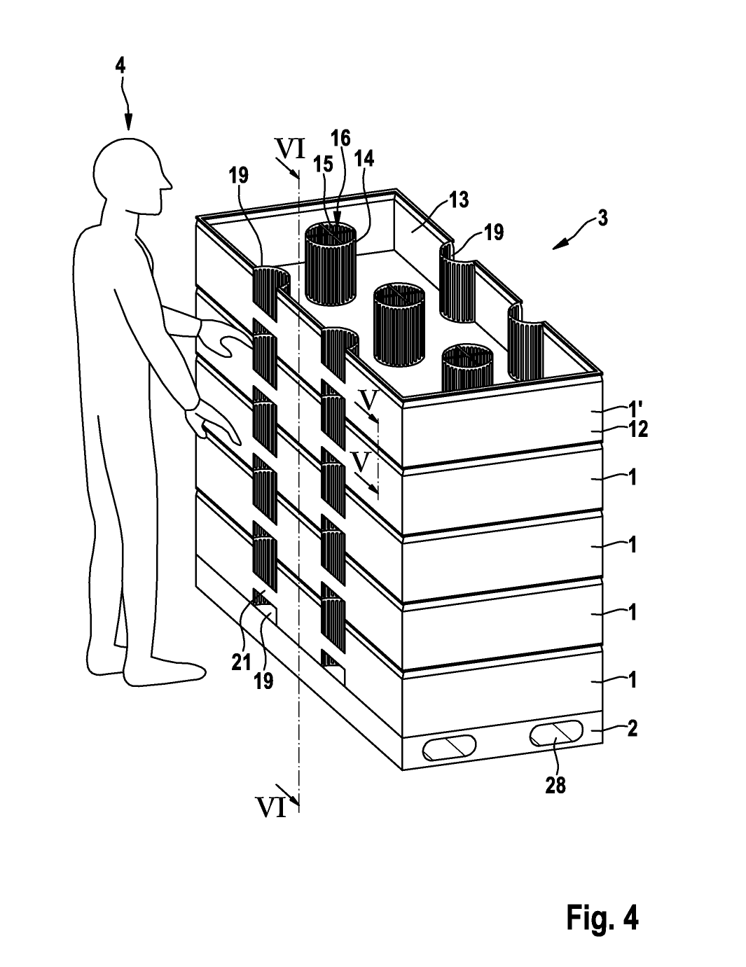

Each column 14 has a height h_{C} which corresponds approximately to the height of the side walls 12,13 (including the floor thickness), so that the columns 14 are adapted for serving as support columns for supporting the floor 11 of a further broiler transport container 1 stacked on top of the broiler transport container 1 as shown in FIGS. 4-6A.

The columns 14 have a hollow 16 at the centre and are cylindrical with a constant diameter dc, except for a small angled section 17 being provided at the joint with the floor 11. This angled section not only strengthens the structure, but also guides a column 14 of another container 1 to project into the hollow as will described below.

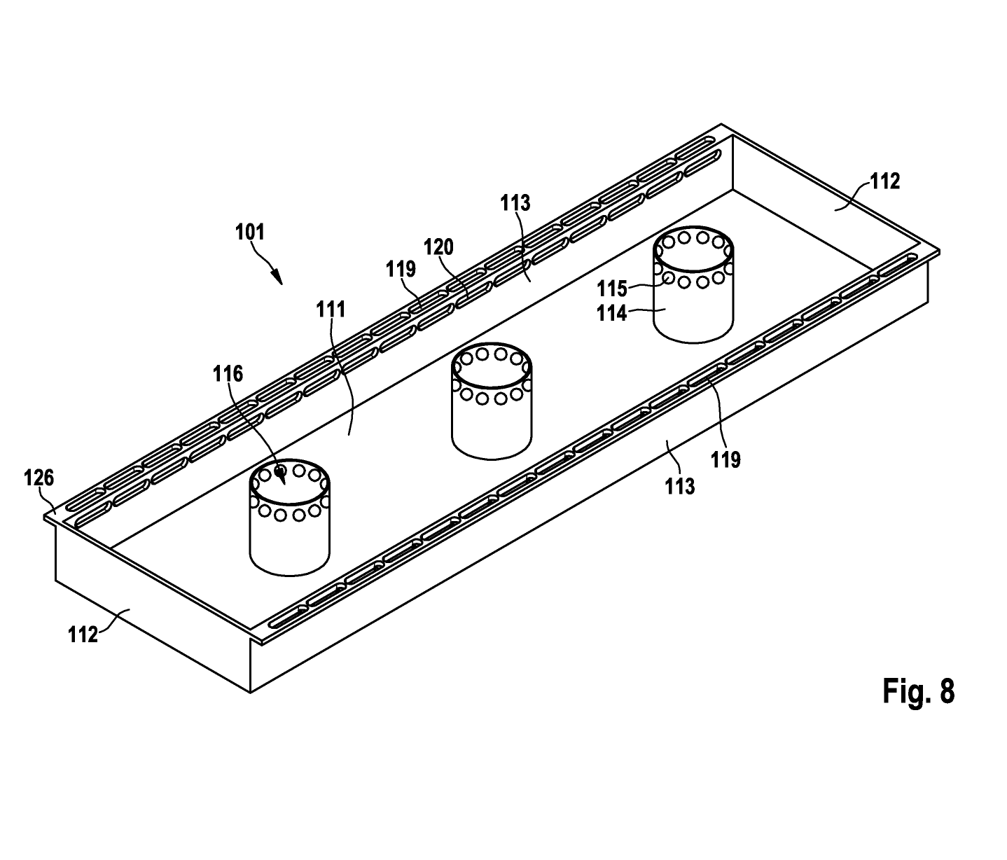

All columns 14 are provided with elongate openings 15 extending over almost the entire height of the column 14. These openings 15 contribute to minimizing the weight of the broiler transport container 1, but do not involve the risk of the toes of the broilers getting caught as they are elevated above the floor. The openings 15 here have a total opening area corresponding to approximately 40% of the total surface area of the column 14, but if a smaller opening area is desired in order to make the column 14 stronger and/or stiffer, the openings 15 may be shorter and/or narrower. Such shorter columns 14 preferably have their lower ends located at a distance from floor 11 so that columns 14 have a circular wall section without openings at the lower end, like the lower section on the columns 14 illustrated in the embodiment of FIG. 8.

The columns 14 may also be of a closed design, i.e. without any opening 15. The number of columns 15 and their positions may vary within the inner volume.

At the upper end of each column 14 a broiler barrier 18 in form of a cross is spanning the opening of the hollow 16. This cross will contribute to the stability of the column 14, but will also prevent broilers from entering the hollow of the column during loading of broilers into the broiler transport container.

Both longitudinal walls are provided with recesses 19 corresponding in size and shape to half a column 14 and are also provided with openings 20 above the floor, but there is no angled section and no cross. To ensure the stability of the broiler transport container 1, even when fully loaded with broilers a beam 21 spanning across each recess 19 is provided in continuation of the plane of the longitudinal side wall 13. This beam 21 is also suitable for use as a grip when handling the container 1 either by hand or automatically.

The broiler transport container 1 in FIGS. 1-3 has a length of 240 cm, a width along the transverse side walls 12 of 80 cm and a height of 22.5 cm and the diameter of the ventilation columns 14 is 20 cm. Other sizes are of course possible.

The rounded out surfaces and relatively large diameter of the columns 14 and recesses 19 help protect the broilers during transport and when they are loaded into the container 1. If a broiler hits the side of a column 14 or recess there are no sharp edges, which might cause bruising.

FIG. 4 shows five broiler transport containers 1 as the one shown in FIGS. 1-3 stacked on top of each other on a pallet 2 to form a unit 3, preferably a broiler transport unit, which will usually further include a lid or cover (not shown).

An operator 4, who has just filled the fourth broiler transport container from the bottom with broilers (not shown), has put a fifth empty container on top and is ready for loading broilers into it.

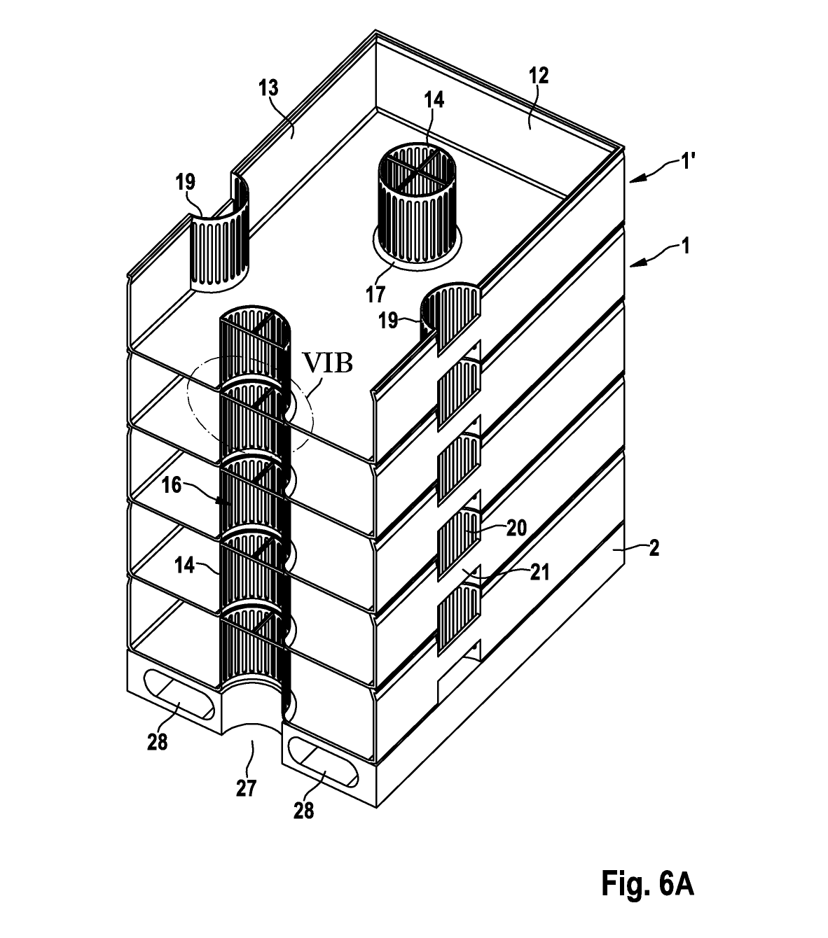

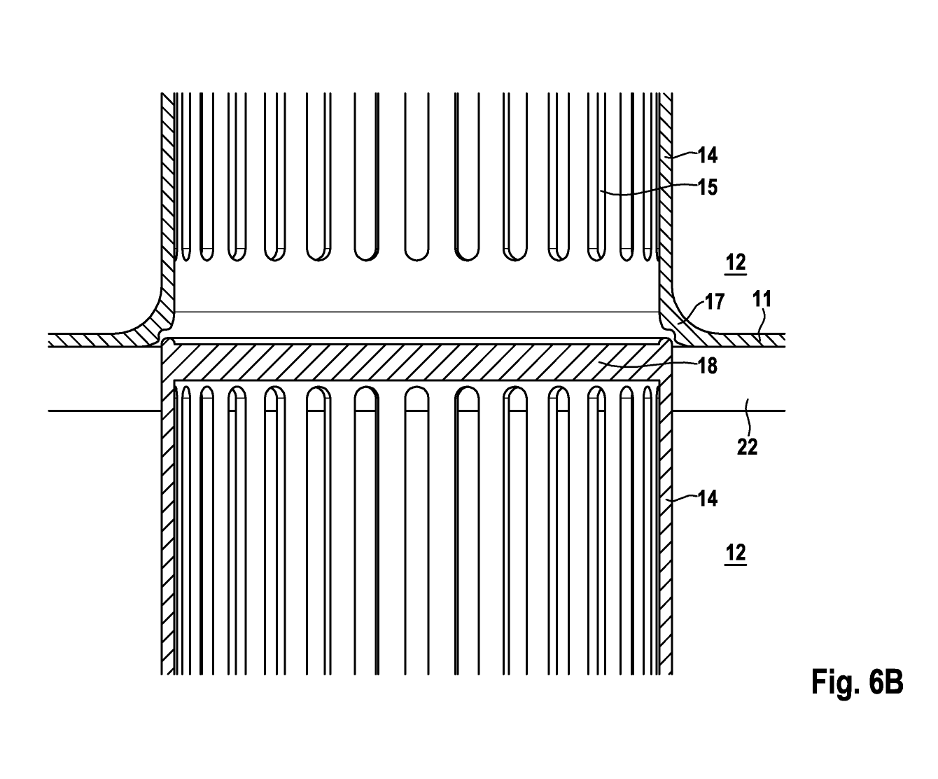

A cross-section through the transport unit 3 along the line VI-VI in FIG. 4 is shown in FIG. 6A. As may be seen, the columns 14 of the five broiler transport containers 1, 1′ are positioned in continuation of each other when the containers 1, 1′ are stacked, so that they form a continuous cylindrical hollow column 16 through the unit. These columns 16 allow the load of the broiler transport container 1, 1′ high in the stack to be transmitted via the columns 14 in the below transport containers 1, 1′ to the pallet 2 at the centre of the transport unit 1, 1′, thus reducing the loads on the side walls and reducing the distances between supports to be spanned by the floors 11. This in turn entails that the floors 11 and outer side walls 12, 13 can be made relatively thin and without strengthening ribs, thus reducing the material consumption and weight of the container 1 and at the same time making it easier to clean.

When broiler transport containers 1 as shown in FIGS. 1-6A are arranged in a stack as shown in FIGS. 4 and 6A, the angled section 17 allows the upper edge of the column 14 of a lower broiler transport container 1 to project slightly into the corresponding column 14 of an upper broiler container 1 as is shown in detail in FIG. 6B. Each column 14 has an upper and a lower end and is provided with an upper corresponding area at the upper end and a lower corresponding area at the lower end. In other word, the upper end of column 14 of a first container 1 is designed such that it is stackable to a form-locked and/or a force-locked fixing with the lower end of a column 14 and vice versa. The broiler transport containers 1 are here shown in the empty state, but when they are filled the floor 11 will deflect slightly so that the two columns 14 come into contact with each other thus forming one load-carrying column as described in the above. Many other embodiments allowing engagement between the columns 14 are possible, one of which will be described below. In the detailed design due care should preferably be taken that the broiler transport containers 1 can be easily loaded on top of each other, be separated, and easily cleaned.

The recesses 19 in the side walls are located above each other in the same way as the columns 14, as is also seen in FIG. 4, so that semi-circular continuous hollow columns are formed at the longitudinal side walls 13. These columns 19 have load bearing properties in themselves and also contribute to the stability of sections of the side walls between the columns 14, thus adding further to the strength and stability of the (transportation) unit.

These advantages could in principle be achieved with massive columns 14, but hollow columns 14 have excellent load bearing capacity with a very limited use of material and thus not only provide strength and stability to the broiler transport container 1 and to the (transport) unit, but also allow the weight of the empty (transport) unit (the tara weight) to be kept low. A comparison to prior art broiler transport units 1 is given in Tables 1 and 2 below.

The prior art systems ID1 and ID2 marketed by the applicant Linco Food Systems and ID3 marketed by Anglia Autoflow Ltd., Diss, Norfolk, England represent one type of transport units, where loose crates or drawers are held in a frame, while the systems ID4-1D7 marketed by Meyn Food Processing Technology B.V., Amsterdam, Netherlands represent another type without such drawers. The use of loose drawers allows a separation of the system, which is advantageous with respect to cleaning of the transport unit, and further allows a destacking before stunning of the broilers, but the weight of such systems is relatively high. As may be seen from Table 2, the ratio between the Unit Basic Weight, i.e. the total weight of the empty transport unit, and the Total Available Area of the floors in the unit for such systems lies in the interval of 60-100 kg/m², whereas this ratio is about 30 kg/m² for the systems without loose drawers. As broiler transport units are typically loaded up to the maximum weight allowed on the truck or trailer, a high tare weight of the transport unit leaves less capacity for transporting the broilers.

With a (transport) unit 3 as shown in FIGS. 1-6A the ratio between the Unit Basic Weight and the Total Available Area for the broilers is very low as illustrated by Examples 1 and 2 (ID8 and ID9), where the ratio is 16-17 kg/m².

Even though some embodiments of the invention may display a slightly higher ratio between Unit Basic Weight and Total Available Area, the present invention provides a considerable advantage over the prior art.

TABLE 1

| | | Container | | | | |
|---|---|---|---|---|---|---|
| | | footprint | | Area | Overall size | Column area |
| ID Make | | L (m) | W (m) | A (m²) | L × W × H (m) | A_{C} (m²) |
| 1 | Linco Maxiload | 1.2 | 1.27 | 1.52 | 2.5 × 1.29 × 1.19 | |
| 2 | Linco Maxiload | 1.2 | 1.27 | 1.52 | 2.5 × 1.29 × 1.46 | |
| 3 | Anglia Autoflow | 1.16 | 0.76 | 0.88 | 2.44 × 1.17 × 1.3 | |
| 4 | Meyn EVO | 2.4 | 1.2 | 2.88 | 2.40 × 1.2 × 1.23 | |
| 5 | Meyn EVO | 2.4 | 1.2 | 2.88 | 2.40 × 1.2 × 1.48 | |
| 6 | Meyn Laco | 2.4 | 1.2 | 2.88 | 2.40 × 1.2 × 1.23 | |
| 7 | Meyn Laco | 2.4 | 1.2 | 2.88 | 2.40 × 1.2 × 1.48 | |
| 8 | Example 1 | 0.8 | 2.4 | 1.76 | 2.40 × 0.8 × 1.16 | 5 × π × 0.10² |
| 9 | Example 2 | 0.8 | 2.4 | 1.76 | 2.40 × 0.8 × 1.41 | 5 × a × 0.10² |

TABLE 2

| | | | | | | Unit basic | | |
|---|---|---|---|---|---|---|---|---|
| | | | Unit basic | | Total | weight/total | Total | Live |
| | | Frame | weight | | available | available | weight | weight |
| | | weight | (empty) | | area | area | loaded | total |
| ID Make | | kg | kg | Tiers | m² | kg/m² | kg | kg |
| 1 | Linco Maxiload | 224 | 400 | 4 | 6.08 | 65.8 | | |
| 2 | Linco Maxiload | 270 | 490 | 5 | 7.60 | 64.5 | 1340 | 850 |
| 3 | Anglia Autoflow | | 350 | 4 | 3.52 | 99.3 | 950 | 600 |
| 4 | Meyn EVO | | 340 | 4 | 11.52 | 29.5 | 1000 | 660 |
| 5 | Meyn EVO | | 395 | 5 | 14.4 | 27.4 | 1220 | 825 |
| 6 | Meyn Laco | | 360 | 4 | 11.52 | 31.3 | 1015 | 655 |
| 7 | Meyn Laco | | 415 | 5 | 14.4 | 28.9 | 1234 | 819 |
| 8 | Example 1 | 40 | 120 | 4 | 7.05 | 17.0 | 600 | 480 |
| 9 | Example 2 | 40 | 140 | 5 | 8.81 | 15.9 | 740 | 600 |

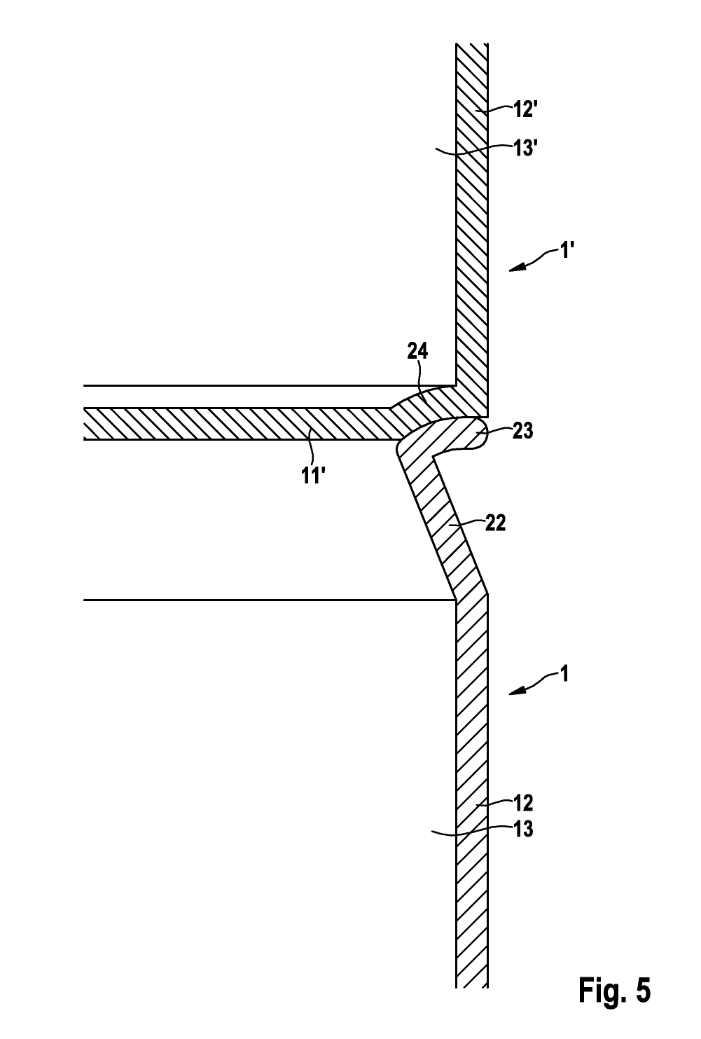

Arranging the (transport) units 3 close to each other, so that they support each other from the sides, will further add to the stability of the broiler transport containers 1 during the transportation. To facilitate such close abutment, the side walls have an upper end and a lower end and are provided with upper corresponding areas at the upper end and with lower corresponding areas at the lower end. Particularly, the upper edges of the side walls 12, 13 of the broiler transport container in FIGS. 1-6A have an angled section 22 projecting slightly inwards towards the inner volume of the container and a flange 23 projecting outwards away from the inner volume. The flange is adapted for engagement with an angled edge section 24 of the floor 11 when containers 1,1′ are stacked on top of each other as shown in FIG. 4, thus allowing the upper container 1′ to rest on the lower container 1 without any part of them projecting over the planes of outer sides of the side walls 12,13 and substantially without limiting the opening of the inner volume as shown in FIG. 5, which is a cross-sectional view of the detail marked V-V in FIG. 4.

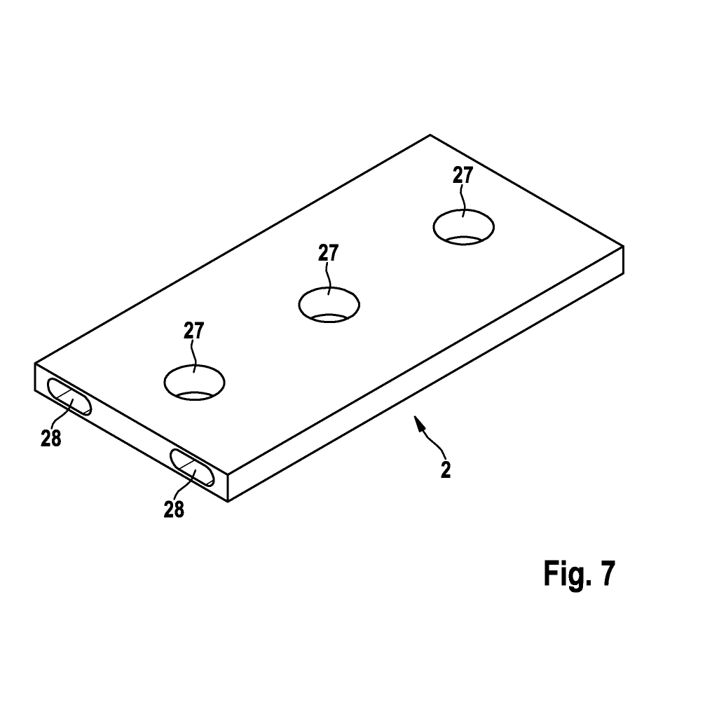

The pallet 2 used at the bottom of the transport unit in FIGS. 4 and 6A and shown in FIG. 7 is intended to provide a stable support for the stack of broiler transport containers 1 and is provided with horizontal openings 28 adapted for engagement with the arms of a fork-lift (not shown) used for handling the (transport) unit 3. In this embodiment, the pallet 2 is provided with a series of openings 27 on the same positions as the columns 14 in the broiler transport containers 1 as also shown in FIG. 7, but this need not be the case. These openings may be used for positioning the lowermost broiler transport container 1 of a stack correctly by aligning the columns 14 therein with the openings 27 and may further be used for positioning the (transport) unit 3 correctly on a truck, trailer or other vehicle.

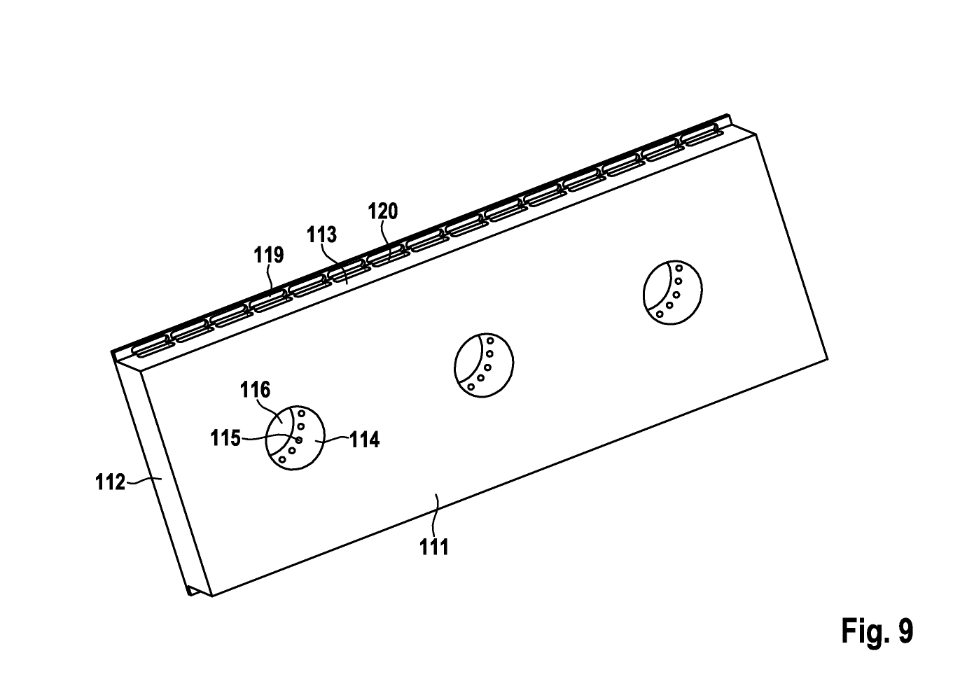

Another embodiment of a broiler transport container 101 is shown in FIGS. 8 and 9. Reference numbers corresponding to those used in FIGS. 1-7 will be used but with 100 added and when nothing else is stated features having such corresponding reference numbers have the same function.

This broiler transport container 101 has three support columns 114 arranged to project from the floor 111, but the container 101 is of simpler design and the openings 115 are provided only at the upper edges of the columns 114. The shape, size and position of the openings may vary greatly without having a considerable negative impact on the strength and/or stiffness of the columns 114. With the design in FIGS. 8 and 9 the risk of broilers becoming stuck is very low.

The container in FIGS. 8 and 9 has no recesses in the side walls. Instead it is provided with a flange 126 projecting away from the inner volume of the container which adds strength and stability to the outer longitudinal side walls 113 without making them difficult to clean. The projecting flanges 126 may also be used as grips when handling the containers, and allow the container to be inserted in a frame system and used in a prior art transportation unit if desired.

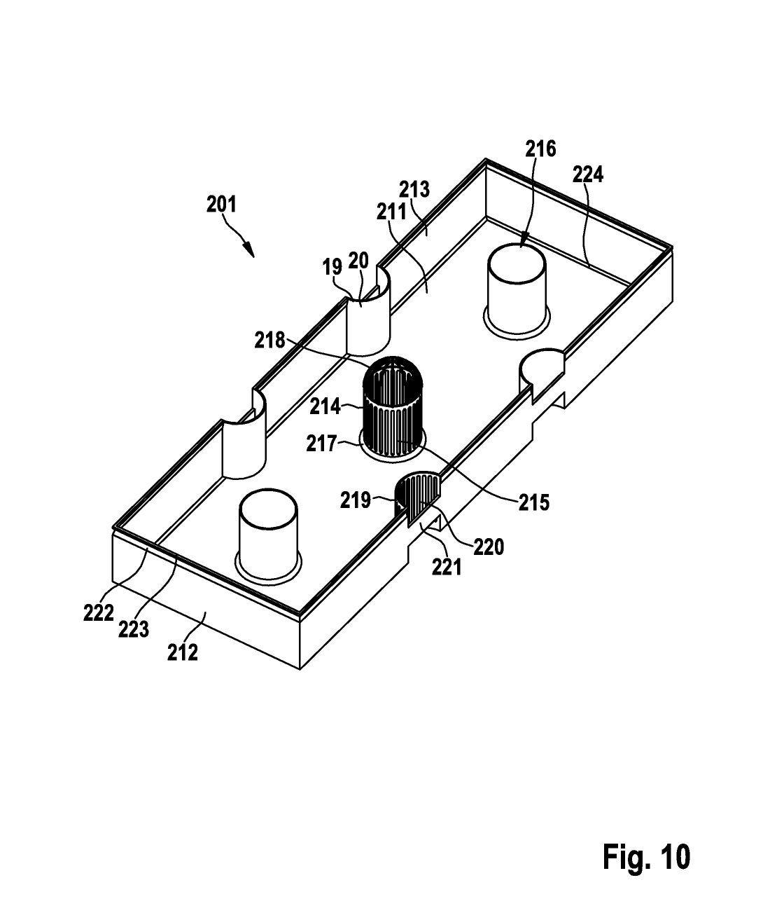

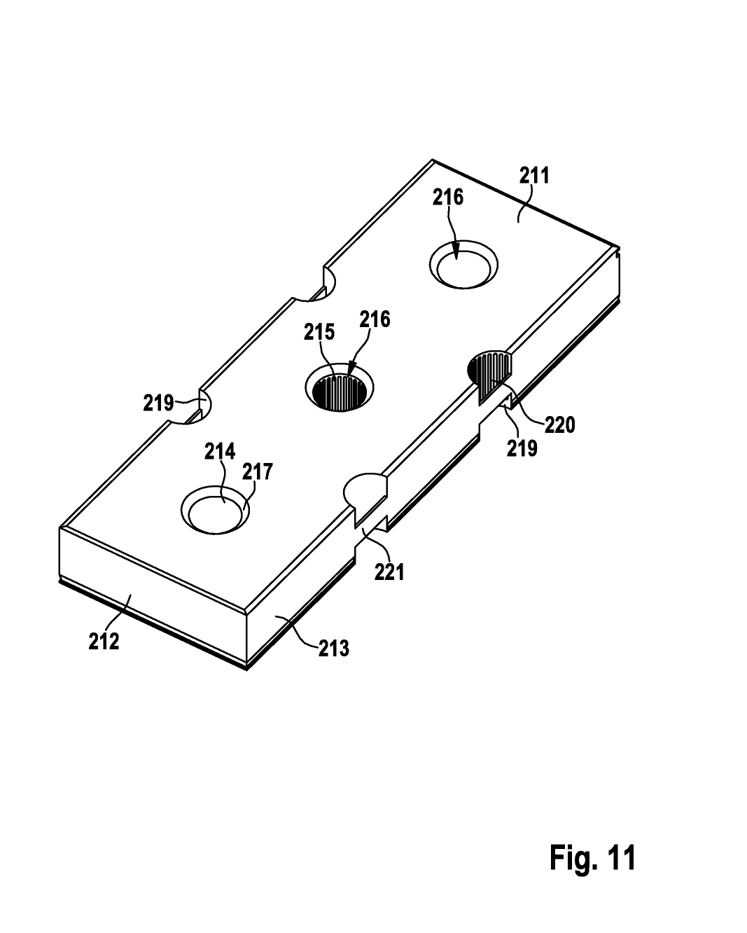

Still another embodiment of a broiler transport container 101 is shown in FIGS. 10 and 11 and here too reference numbers corresponding to those used in FIGS. 1-7 will be used but with 200 added and when nothing else is stated features having such corresponding reference numbers have the same function. It is, however, noted that the illustrations in FIGS. 10 and 11 are highly schematic and that openings 220 are shown only on one column 214 and one recess 219 even though all three columns 214 and all four recesses 219 may be provided with openings in the same manner.

This embodiment differs from that in FIGS. 1-7 in that instead of the cross 18 the ventilation columns 214 are provided with a dome 218 (shown only on the middle column). In addition to preventing broilers from coming into the ventilation channels 216, this dome 218 projects over the upper level of the side walls 212, 213, meaning that when containers of this type are stacked, the dome will be inserted in the hollow of the ventilation column above, thereby contributing to centering the two containers in relation to each other, and the dome may also improve the stability of the entire stack.

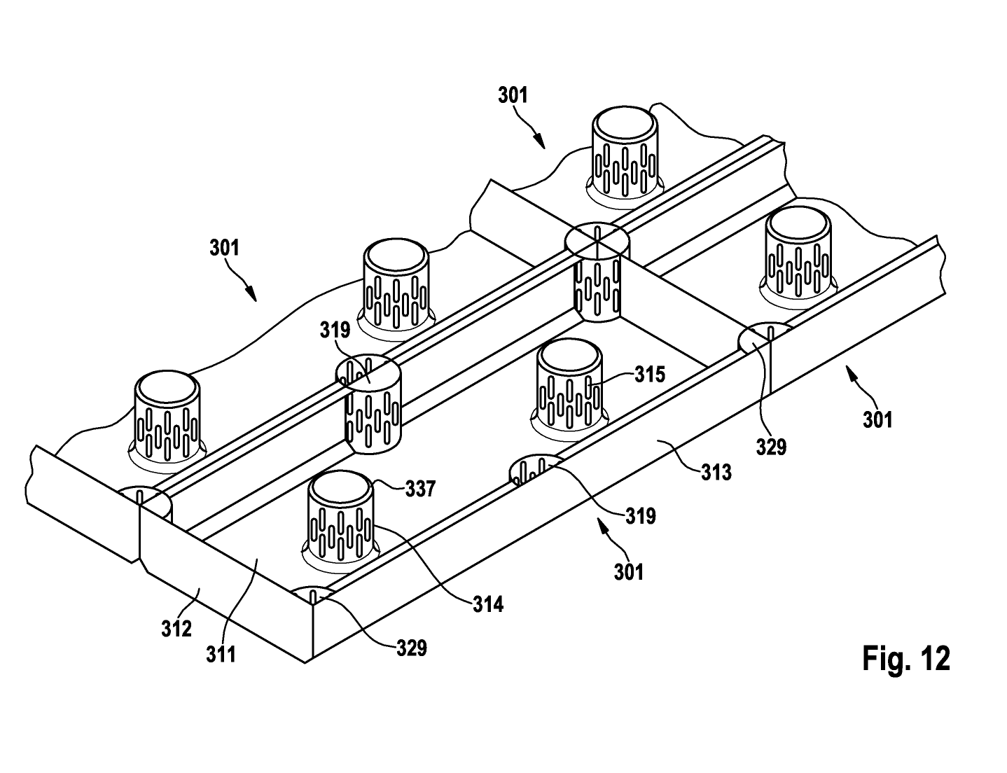

An even more schematic illustration of a yet another embodiment of a broiler transport 301 container is shown in FIG. 12 and here too reference numbers corresponding to those used in FIGS. 1-7 will be used but with 300 added and when nothing else is stated features having such corresponding reference numbers have the same function. This embodiment differs from that in FIGS. 1-7 in that the four recesses have been replaced by two semi-circular columns 319, so that the outer sides of the longitudinal side walls 313 are uninterrupted, and four corner columns 329 each with a quarter-circular crosssection. The closed outer sides and corner columns provide even further stability to the broiler transport container.

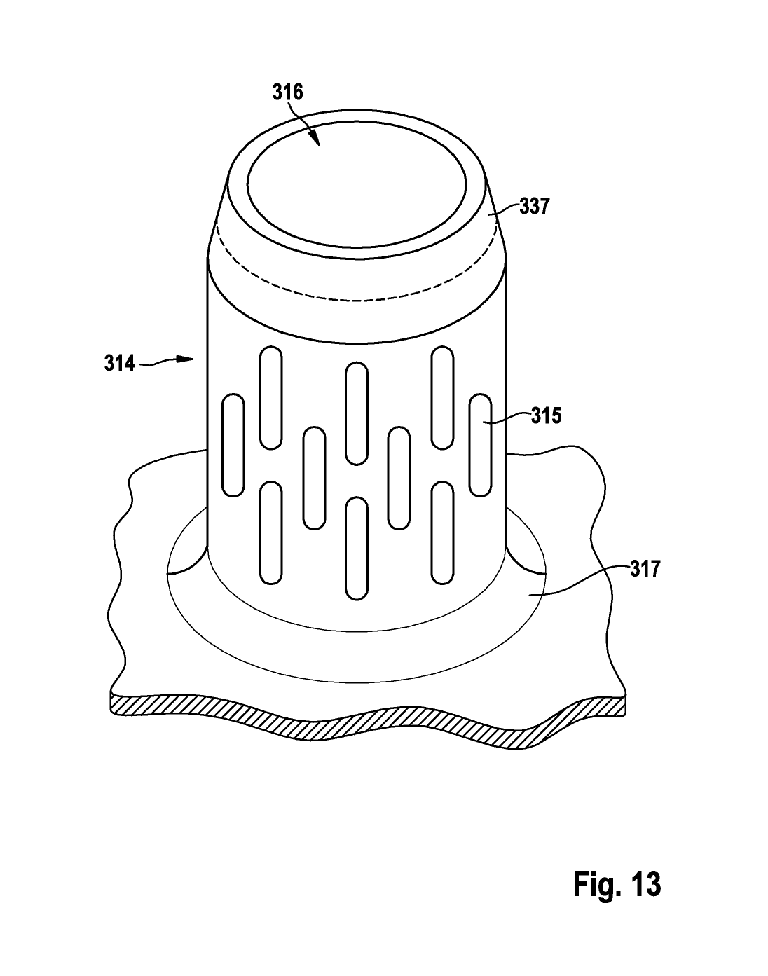

The embodiment in FIG. 12 further differs in that there are only two columns 314 each of which are embodied substantially as shown in FIG. 13. As may be seen, the upper section 337 of these columns 314 has a reduced diameter in relation to the rest of the column. This allows the upper section 337 to be inserted in the hollow at the bottom of a corresponding column of another container as described with reference to the dome in FIG. 10 and the shoulder formed at the transition between the main body of the column 314 and the upper section 337 will come into engagement with the underside of the other container as described with reference to FIG. 6B. When dimensioned appropriately such columns 314 may even snap-lock to each other. Another difference lies in the design of the openings 315, which are here elongated but shorter than those in the embodiment in FIGS. 1-3 and distributed in an even pattern over the columns.

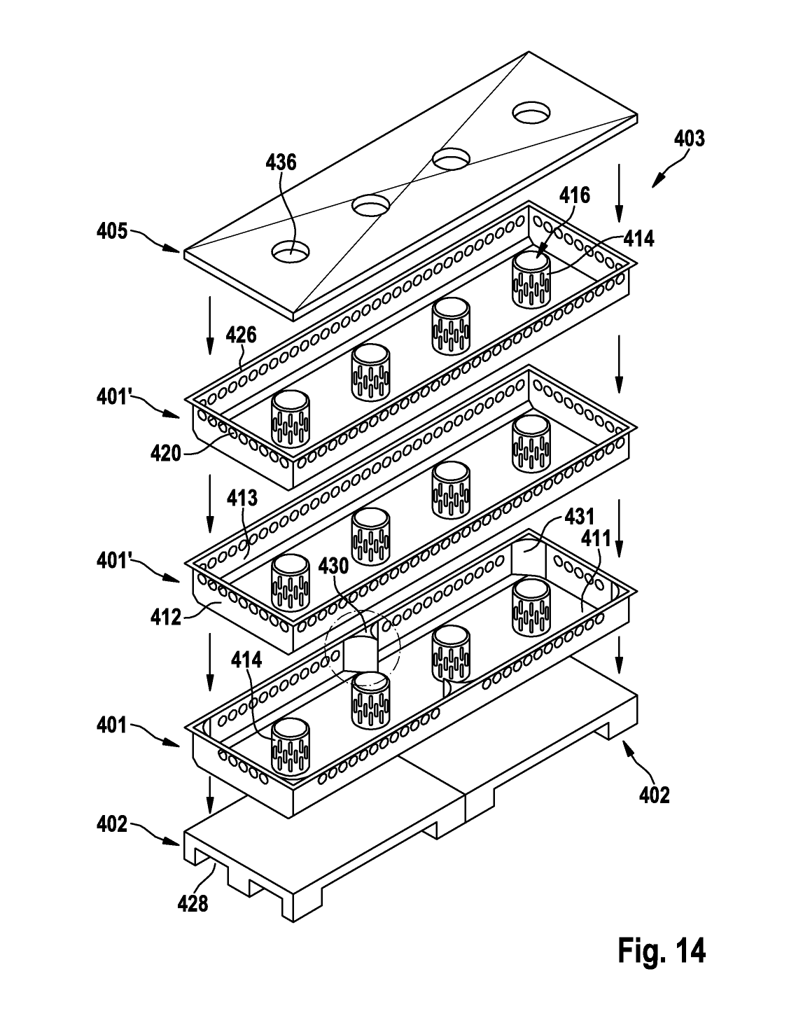

Two still further embodiments of broiler transport containers 401, 401′ are shown in FIG. 14, where a container 401 with reinforcements is arranged on top of two pallets 402 and where two containers 401′ of a relatively light construction are arranged on top thereof and covered with a lid 405 to form a transport unit 403. Here too reference numbers corresponding to those used in FIGS. 1-7 will be used but with 400 added and when nothing else is stated features having such corresponding reference numbers have the same function.

Both of these embodiments of the container are provided with ventilation columns 414 resembling that in FIG. 13 and with openings 420 along the upper edges of the side walls 412, 413. These features have the same functions as described above with reference to other embodiments and will therefore not be described in further detail here.

The use of two pallets 402 arranged adjacent to each other allows the use of smaller pallets and thus potentially the use of standard pallets and/or the same pallets both for smaller and larger versions of the broiler transport container. In this embodiment, the openings 428 in the pallets adapted for engagement with the arms of a fork-lift (not shown) are downwards open, which reduces the risk of them catching dirt and makes them easier to clean than the pallet in FIG. 7.

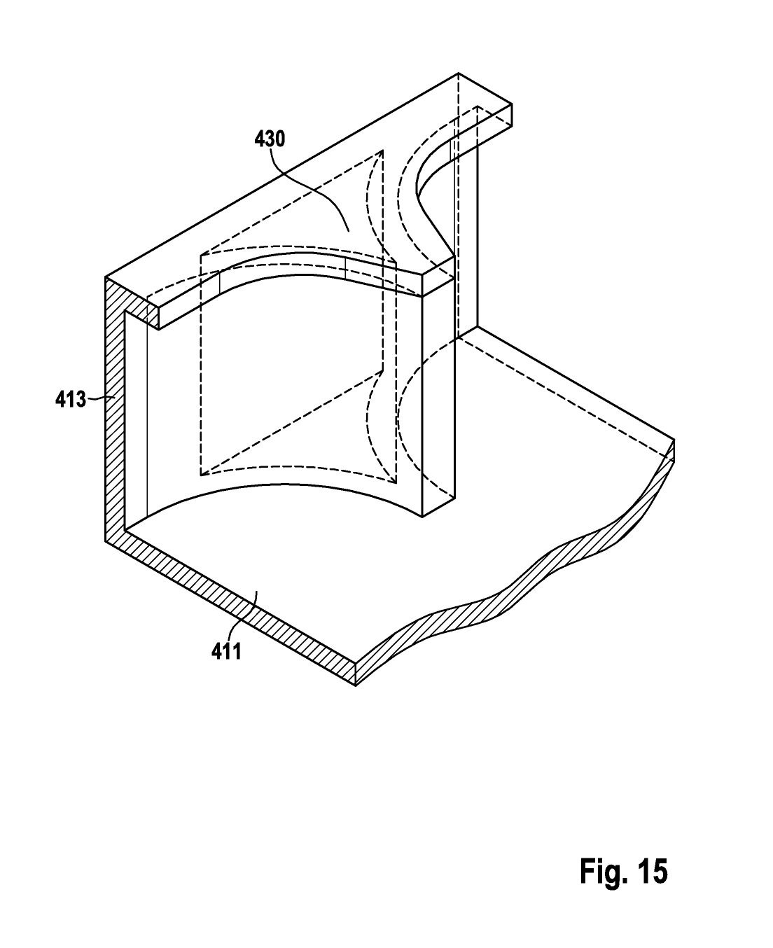

The lowermost broiler transport container 401 differs from those previously described in having substantially triangular reinforcement sections 430, 431 at the corners and at the middle of the longitudinal side walls 413. In this embodiment the reinforcing sections, which may be massive or hollow as indicated by the broken lines in FIG. 15, are made with rounded surfaces facing the inner volume of the container in order to facilitate cleaning and prevent damages to the broilers as described with reference to the columns above, but other shapes may be employed. The reinforcing sections will also serve as a support for the container 401′ arranged on top of the reinforced container 401 and thus supplement the support provided by the columns 414.

Though the reinforcement is here shown only on the lowermost container 401 in the transport unit 403, it should be understood that such containers may be used higher in the stack, particularly if the stack includes more than three containers and/or if they are heavily loaded. Experiments have shown that the second lowest container in a stack will often be the one subject to the highest loads since it carries the weight of all of the loaded containers above and does not have the surface support provided by the pallet(s) but only rests on the lowermost container.

As described above, the columns 414 forms a vertical column when arranged on top of each other and the lid 405 is here provided with an opening 436 in continuation of the column. This opening may be used for positioning of the lid and it is to be understood that similar openings are provided above the other columns 414.

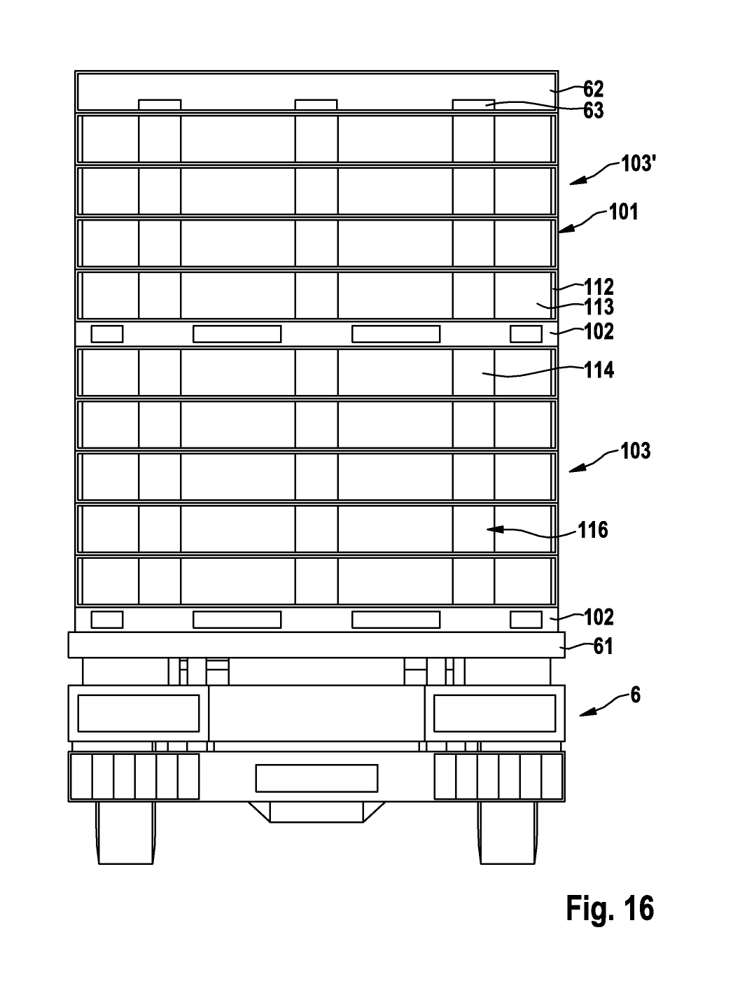

The back end of a truck or trailer 6 loaded with transport units 103, 103′ built from the type of broiler transport containers 101 shown in FIGS. 8 and 9 is shown in FIG. 16. Two layers of such transport units are arranged on top of each other on the floor 61. The transport units 103 in the lowermost layer each include five broiler transport containers, while the transport units 103′ in the uppermost layer include four containers each. The longitudinal side walls 113 facing towards the back of the trailer are not shown, in order to expose the inner volumes of the broiler transport containers. Here too, the columns 114 form vertical common columns 116.

Each transport unit 103, 103′ has a width corresponding to the width of the floor 61 of the truck trailer so that it is only necessary to load one row of transport units, but it will be understood that it would also be possible to use broiler transport containers of a smaller size and then arrange them in two or more rows extending in the length direction of the floor.

The roof 62 of the truck trailer is provided with engagement means 63 each being in engagement with one of the columns 116 during transport. In order to achieve this engagement, the roof can be raised and lowered by hydraulic actuators, as is known from current broiler transportation trucks and trailers in order to allow fixation of the transport units.

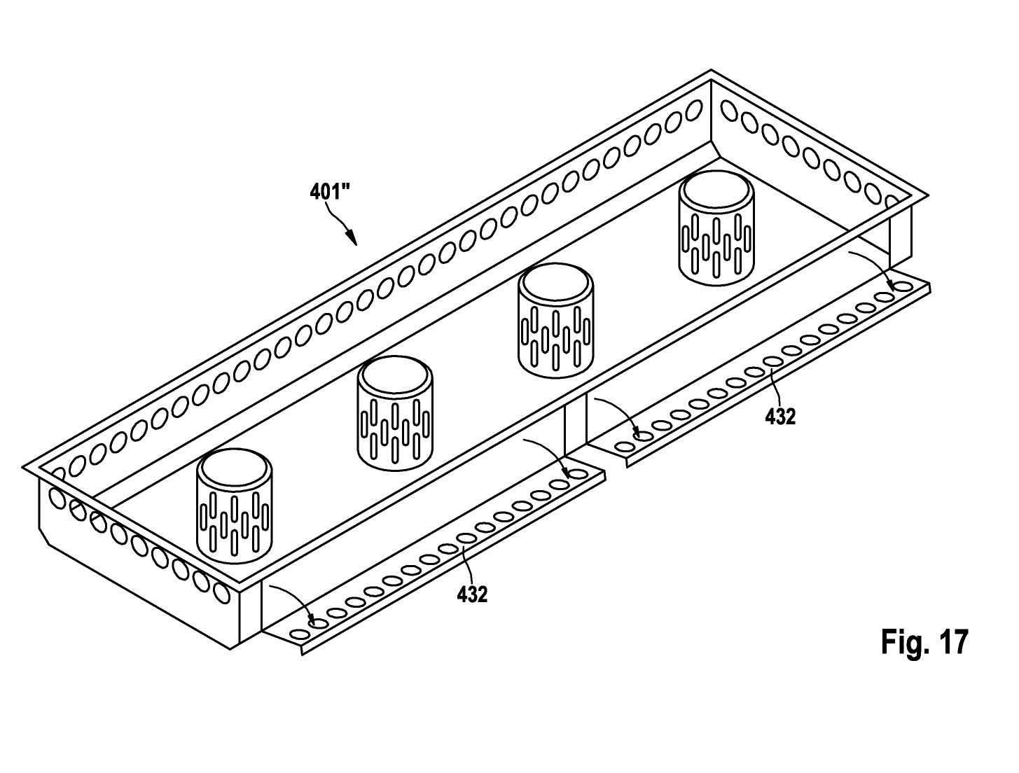

When having arrived at the slaughterhouse the broilers are usually stunned and this often happens while they are still in the broiler transport container. After the stunning the broiler transport units have to be emptied rather quickly to prevent the hearts of the broilers to stop before they are slaughtered. To facilitate the emptying the broiler transport containers 401″ may be provided with gates or doors 432 as shown in FIG. 17. The number of gates or doors may vary.

All of the embodiments described above rely on the use of large broiler transport containers with three or more column, but it is also within the scope of the invention to use containers with fewer columns.

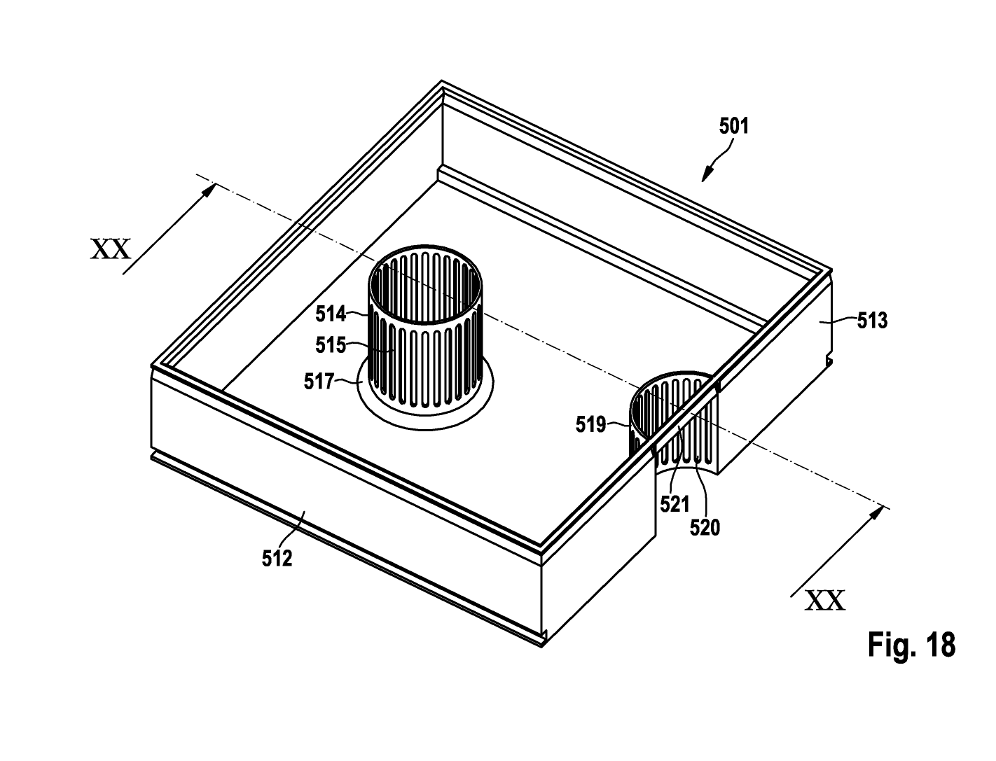

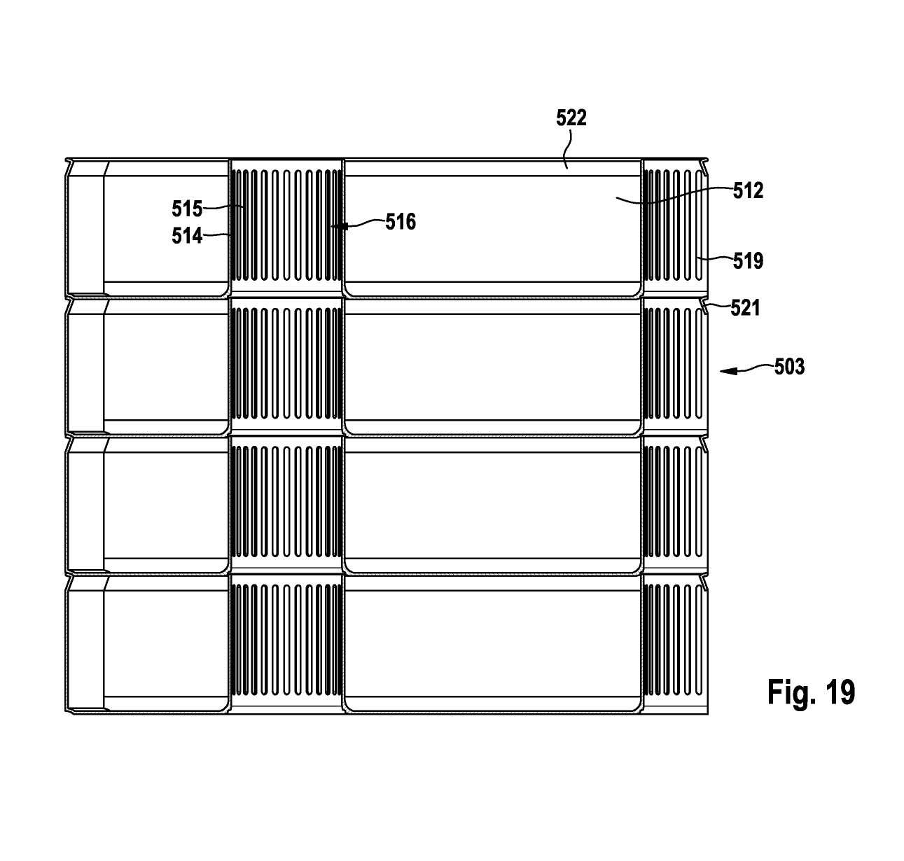

One example of a broiler transport container system with only one column 514 and one recess 519 is illustrated in FIGS. 18 and 19, and again reference numbers corresponding to those used in FIGS. 1-7 are used, but with 500 added, and when nothing else is stated features having such corresponding reference numbers have the same function When such broiler transport containers are arranged in on top of each other in stacks as shown in FIG. 19, the column 514 forms a common column 516 extending vertically through all the units in the same way as shown and described with reference to FIGS. 6A and 6B.

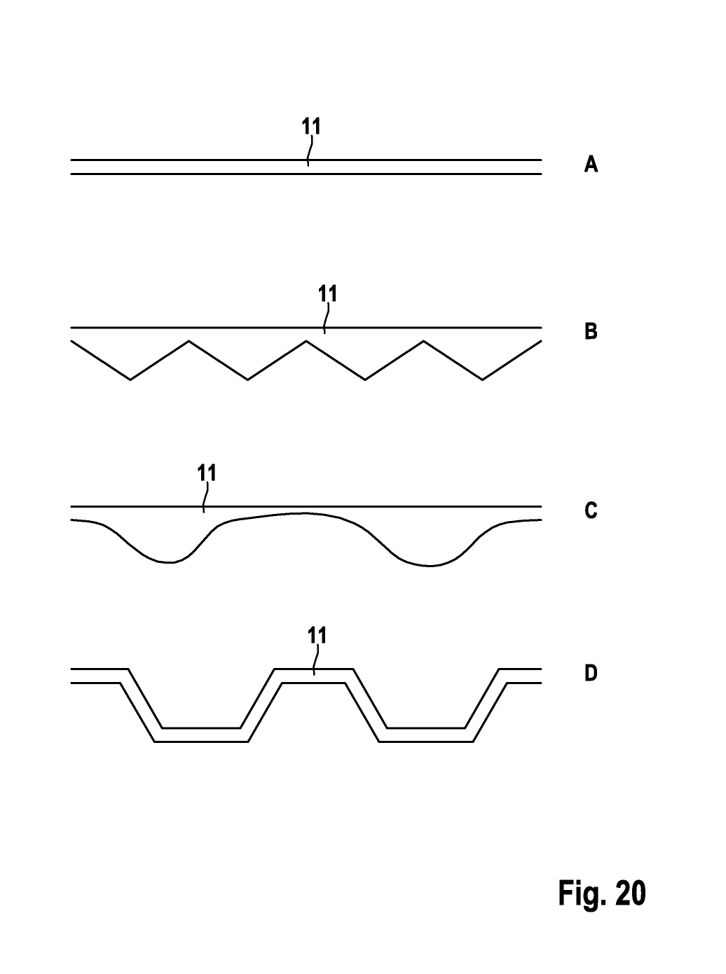

In the above all broiler transport containers have been shown and described as having a plane floor as shown in cross-section at the top of FIG. 20, but other shapes are also possible including having triangular or rounded thickenings as shown in the middle of FIG. 20 or using a trapezoidal sheet as shown at the bottom of FIG. 20. Common to all of these embodiments is that they are composed of planar, plate shaped sections so that the outer surfaces are easy to clean. Similar considerations apply to the outer side walls.

Details of the various embodiments can be combined into further embodiments within the scope of the patent claims.

1. A broiler container, designed and adapted for accommodating and holding broilers, having a floor and side walls defining an inner volume, the broiler container designed and adapted to be stackable with broiler containers of the same design, characterized in that at least one support column extends from the floor up through the inner volume, that the support column is distanced from all the side walls providing space for at least one broiler in between the support column and any of the side walls, and that the support column has a height to support the floor of a further broiler container stacked on top of the broiler container.

2. The broiler container according to claim 1, characterized in that it is sized as well as designed and adapted for transport of at least five live broilers.

3. The broiler container according to claim 1, characterized in that the floor has an outer surface, which outer surface is plate shaped and without openings in the areas between the at least one support column and the side walls.

4. The broiler container according to claim 1, characterized in that the floor has an inner surface, which inner surface is plate shaped and without openings in the areas between the at least one support column and the side walls.

5. The broiler container according to claim 1, characterized in that the floor has a plurality of planar, plate shaped sections.

6. The broiler container according to claim 1, characterized in that the broiler container has four side walls forming two pairs of opposed side walls, that the at least one support column is positioned on the floor at approximately midway between one pair of opposed side walls, and distributed between the other pair of opposed side walls with a spacing of approximately D/(N+1), where D is the distance between the other pair of opposed side walls, and N is the number of support columns in the broiler container.

7. The broiler container according to claim 1, characterized in that the at least one support column has an annular cross-section with a hollow center extending along the height of the support column.

8. The broiler container according to claim 1, characterized in that the support column has an outer diameter in the range from 7 cm to 30 cm, particularly in the range from 10 cm to 24 cm, preferably in the range from 12 cm to 21 cm.

9. The broiler container according to claim 8, characterized in that the at least one support column has an upper end and a lower end and is provided with an upper corresponding area in its upper end and a lower corresponding area in its lower end.

10. The broiler container according to claim 8, characterized in that the side walls have an upper end and a lower end and are provided with upper corresponding areas in the upper end and lower corresponding areas in the lower end.

11. The broiler container according to claim 1, characterized in that the length of the broiler container is in the range of 2.10 m to 2.80 m, preferably about 2.4 m, and that the width of the broiler container is in the range of 0.70 m to 2.6 m, preferably in the range of 0.70 to 0.90 m, and particularly preferably about 0.80 m.

12. The broiler container according to claim 1, characterized in that the side walls are substantially planar, and preferably plate shaped.

13. The broiler container according to claim 1, characterized in that the broiler container is made of plastic material, preferably by injection moulding.

14. A unit, designed and adapted for accommodating and holding live broilers during breeding and/or during transportation to a slaughterhouse and/or during lairage of the broilers before processing near the slaughterhouse, comprising at least two broiler containers, characterized in that the broiler containers are designed according to claim 1.

15. The unit according to claim 14, characterized in that broiler containers in stacked configuration on a pallet support constitute the unit, the unit having a basic weight and a total floor area, which total floor area is the sum of the floor areas of the broiler containers in the unit, and that the unit basic weight (in kg) divided by the total floor area (in m²) is at the most 24.0 (kg/m²), and preferably the unit basic weight (in kg) divided by the total floor area (in m²) is in the range from 5 to 24 kg/m², particularly preferably in the range from 10 to 20 kg/m².

16. The unit according to claim 14, characterized in that the broiler container has upper corresponding areas and lower corresponding areas, which upper corresponding areas fit with the lower corresponding areas on a further broiler container stacked on top of the broiler container, and that broiler containers stacked on pallet support as a unit are self-supporting via said upper corresponding areas and lower corresponding areas.

17. The unit according to claim 16, characterized in that the upper corresponding areas on the side walls protrude upwards at intermediate portions of the side walls, leaving openings in between upper ends of the intermediate portions and a further broiler container stacked on top of the broiler container.
